(19) United States
(12) Patent Application Publication
(10) Pub. No.: US 2014/0247263 A1
(43) Pub. Date: Sep. 4, 2014

(54) STEERABLE DISPLAY SYSTEM

(71) Applicant: Microsoft Corporation, Redmond, WA (US)

(72) Inventors: Andrew Wilson, Seattle, WA (US); Hrvoje Benko, Seattle, WA (US); Shahram Izadi, Cambridge (GB)

(73) Assignee: Microsoft Corporation, Redmond, WA (US)

(21) Appl. No.: 14/037,986

(22) Filed: Sep. 26, 2013

Related U.S. Application Data
(60) Provisional application No. 61/772,280, filed on Mar. 4, 2013.

(51) Int. Cl. G06T 17/00

(52) U.S. Cl. CPC G06T 17/00
USPC 345/420

(57) ABSTRACT

A steerable display system includes a projector and a projector steering mechanism that selectively changes a projection direction of the projector. An aiming controller causes the projector steering mechanism to aim the projector at a target location of a physical environment. An image controller supplies the aimed projector with information for projecting an image that is geometrically corrected for the target location.

### CROSS REFERENCE TO RELATED APPLICATIONS

This application claims priority to U.S. Provisional Patent Application No. 61/772,280, filed Mar. 4, 2013, and entitled “STEERABLE AUGMENTED REALITY WITH THE BEAMATRON”, the entirety of which is hereby incorporated herein by reference.

### BACKGROUND

Projectors are often used to display images on fixed screens. For example, movie theaters and home theaters often utilize projectors to create large displays. As another example, projectors can be used in an office setting to display presentation slides or other visual content in a conference room. However, projectors are traditionally stationary and aimed at a non-moving projection screen.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to embodiments of the present disclosure, steerable display system includes a projector and a projector steering mechanism that selectively changes a projection direction of the projector. An aiming controller causes the projector steering mechanism to aim the projector at a target location of a physical environment. An image controller supplies the aimed projector with information for projecting an image that is geometrically corrected for the target location.

### BRIEF DESCRIPTION OF THE DRAWINGS

FIG. 1 shows an example steerable display system in accordance with an embodiment of the present disclosure.

FIG. 2 shows another example steerable display system in accordance with an embodiment of the present disclosure.

FIG. 3 shows another example steerable display system in accordance with an embodiment of the present disclosure.

FIG. 4 shows a geometrically corrected image projected from a steerable display system from the perspective of a user viewpoint.

FIG. 5 shows the geometrically corrected image projected from the steerable display system of FIG. 4 from the perspective of the projector.

FIG. 6 shows an example steerable display system projecting a geometrically corrected image over uneven terrain.

FIG. 7 shows a pair of steerable display systems cooperating to project a projection image.

FIG. 8 schematically shows an example steerable display system in accordance with an embodiment of the present disclosure.

### DETAILED DESCRIPTION

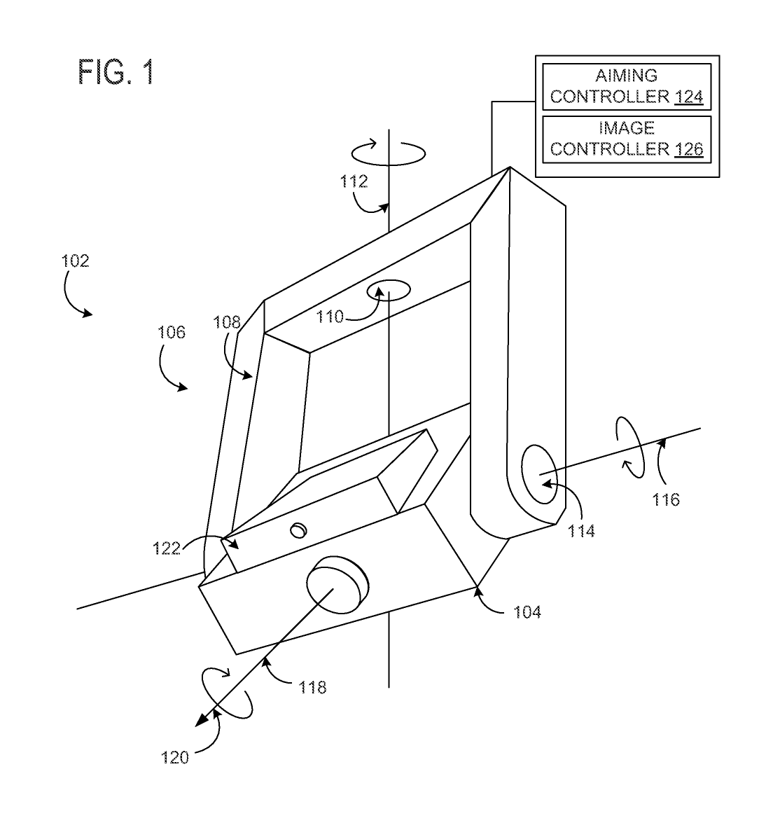

FIG. 1 shows a nonlimiting example of a steerable display system 102 in accordance with an embodiment of the present disclosure. Steerable display system 102 includes a projector 104 configured to project light to form display images on various different display surfaces.

Steerable display system 102 also includes a projection steering mechanism 106. In the illustrated embodiment, projection steering mechanism 106 includes a frame 108 configured to pivot at a mount 110 about a yaw axis 112. Frame 108 also is configured to pivotably hold projector 104 at projector mounts 114 such that the projector is able to pivot about a pitch axis 116. In the illustrated embodiment, projector 104 is configured to virtually or mechanically pivot projected images about a roll axis 118. As such, projection steering mechanism 106 is able to change the projection direction 120 of the projector by mechanically and/or virtually rotating the projector about perpendicular yaw, pitch, and roll axes.

Steerable display systems in accordance with the present disclosure may include a plurality of different projectors independently aimable by a plurality of different projection steering mechanisms.

Frame 108, mount 110, and mounts 114 illustrated in FIG. 1 are nonlimiting examples. Other mechanical arrangements such as various one-, two-, and three-degree-of-freedom gimbals may be used without departing from the scope of this disclosure.

Projection steering mechanisms in accordance with the present disclosure may be mounted to a stationary structure. For example, projection steering mechanism 106 may be mounted to a floor, wall, or ceiling, or designed with a pivoting base that can be placed on a floor or table, for example.

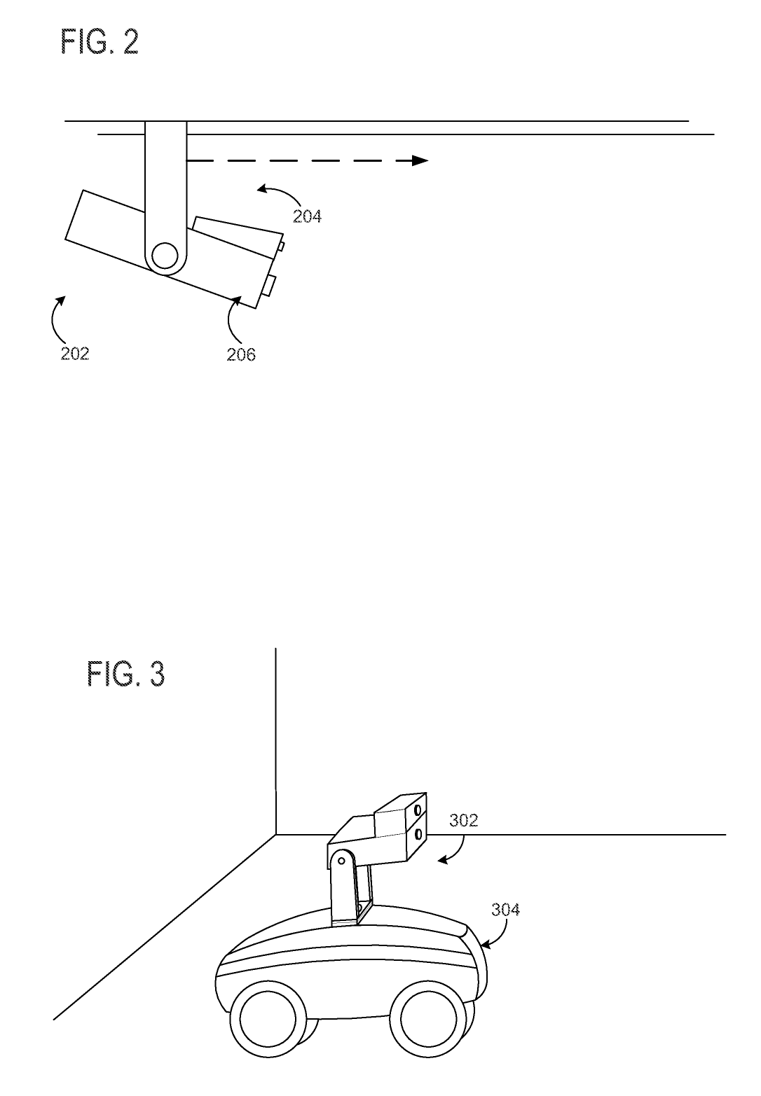

In other embodiments, a projection steering mechanism may be mounted to a moveable object. As one example, FIG. 2 shows a steerable projection system 202 with a projection steering mechanism 204 configured to translate a horizontal position of projector 206. Projection steering mechanism 204 is also configured to change the projection direction of projector 206 about perpendicular yaw, pitch, and roll axes. As such, the steerable projection system 202 of FIG. 2 is a four degree of freedom system that is capable of pivoting about the yaw, pitch, and roll axes and translating linearly in one dimension. In other embodiments, five or six degree of freedom systems may be implemented in which the projector may be translated in two or three dimensions. Alternatively, projector 206 may be translated in one or more dimensions without rotational capabilities. Thus various embodiments of a steerable projection system may be implemented with any combination of one to six degrees of freedom without departing from the scope of this disclosure.

Any method may be used to translate the projector. For example, horizontal translation of projector 206 may be achieved via ceiling- or floor-mounted rails or tracks. As another example, a projector may be moved by a vehicle. For example, FIG. 3 shows a projection steering mechanism 302 mounted to a wheeled robot 304. As another example, a projection steering mechanism may be mounted to an aerial or aquatic vehicle.

A projection steering mechanism in accordance with the present disclosure aims a projector so that an image may be projected to any surface in a physical environment (e.g., surfaces in a living room). Moving a projector that is projecting images may cause projected images to be unstable. To mitigate image jitter, the steerable display system may optionally include a projection stabilizer configured to stabilize images projected by the projector. Such stabilizers may include mechanical stabilizers that mechanically smooth movement of the projection optics and/or virtual stabilizers that digitally manipulate the images projected from the projection optics.

Turning back to FIG. 1, steerable display system 102 may include an aiming controller 124 to cause projection steering mechanism 106 to aim projector 104 at a target location of a physical environment. For example, projector 104 may be aimed at a particular portion of a wall, at a moving toy, or even at a portion of a person's body, the position of which may be determined by a virtual skeleton, for example. Aiming controller 124 may be on board or off board projection steering mechanism 106. In off board embodiments, the aiming controller may communicate with the projection steering mechanism via wired or wireless communication linkages.

Steerable display system 102 includes a depth camera 122 to three-dimensionally model a physical environment. Such modeling may allow the steerable display system to recognize the three-dimensional position of various stationary or moving targets onto which it projects display images.

Depth camera 122 may be mounted so that projection steering mechanism 106 aims depth camera 122 along with projector 104. Alternatively, a depth camera may be aimed independently from projector 104. It should be understood that one or more depth cameras may be used.

In some embodiments, brightness or color data from two, stereoscopically oriented imaging arrays in the depth camera may be co-registered and used to construct a depth map. In other embodiments, a depth camera may be configured to project onto a target subject a structured infrared (IR) illumination pattern comprising numerous discrete features—e.g., lines or dots. An imaging array in the depth camera may be configured to image the structured illumination reflected back from the target subject. Based on the spacings between adjacent features in the various regions of the imaged target subject, a depth map of the target subject may be constructed. In still other embodiments, the depth camera may project a pulsed infrared illumination towards the target subject. A pair of imaging arrays in the depth camera may be configured to detect the pulsed illumination reflected back from the target subject. Both arrays may include an electronic shutter synchronized to the pulsed illumination, but the integration times for the arrays may differ, such that a pixel-resolved time-of-flight of the pulsed illumination, from the illumination source to the target subject and then to the arrays, is discernible based on the relative amounts of light received in corresponding elements of the two arrays.

Depth cameras, as described above, are naturally applicable to any physical object. This is due in part to their ability to resolve a contour of an object even if that object is moving, and even if the motion of the object is parallel to an optical axis of the depth camera 122. Any suitable depth camera technology may be used without departing from the scope of this disclosure.

The perspective of the depth camera may be carefully tracked so that depth information obtained at different camera locations and/or aiming directions may be transformed into a common coordinate system. In this way, depth camera 122 may model a physical environment as a plurality of voxels (i.e. volume elements), a plurality of points in a point cloud, geometric surfaces comprised of a plurality of polygons, and/or other models that may be derived from one or more different imaging perspectives.

Steerable display system 102 includes an image controller 126 to supply an aimed projector with information for projecting an image that is geometrically corrected for a target location. The image may be geometrically corrected based on a model formed by depth camera 122, for example. Image controller 126 may be on board or off board projection steering mechanism 106. In off board embodiments, the image controller may communicate with the projection steering mechanism via wired or wireless communication linkages.

Steerable display system 102 may also geometrically correct projected images for a particular user's viewpoint. As such, the steerable display system may include a viewpoint locator configured to locate a viewpoint of a human subject present in the physical environment. It is to be understood that any technique may be used to determine a user viewpoint. As one example, a user's viewpoint may be estimated based on three dimensional sound source localization.

As another example, a user's viewpoint may be determined from information derived from the depth camera. In some embodiments, a steerable display system may analyze the depth data from the depth camera to distinguish human subjects from non-human subjects and background. Through appropriate depth-image processing, a given locus of a depth map may be recognized as belonging to a human subject. In a more particular embodiment, pixels that belong to a human subject are identified by sectioning off a portion of the depth data that exhibits above-threshold motion over a suitable time scale, and attempting to fit that section to a generalized geometric model of a human being. If a suitable fit can be achieved, then the pixels in that section are recognized as those of a human subject. In other embodiments, human subjects may be identified by contour alone, irrespective of motion.

In one, non-limiting example, each pixel of a depth map may be assigned a person index that identifies the pixel as belonging to a particular human subject or non-human element. As an example, pixels corresponding to a first human subject can be assigned a person index equal to one, pixels corresponding to a second human subject can be assigned a person index equal to two, and pixels that do not correspond to a human subject can be assigned a person index equal to zero. Person indices may be determined, assigned, and saved in any suitable manner.

After one or more users are identified, a steerable display system may begin to process posture information from such users. The posture information may be derived computationally from depth video acquired with the depth camera. At this stage of execution, additional sensory input—e.g., image data from a color camera or audio data from a listening system—may be processed along with the posture information.

In one embodiment, a steerable display system may be configured to analyze the pixels of a depth map that correspond to a user in order to determine what part of the user's body each pixel represents. A variety of different body-part assignment techniques can be used to this end. In one example, each pixel of the depth map with an appropriate person index may be assigned a body-part index. The body-part index may include a discrete identifier, confidence value, and/or body-part probability distribution indicating the body part or parts to which that pixel is likely to correspond. Body-part indices may be determined, assigned, and saved in any suitable manner.

In one example, machine-learning may be used to assign each pixel a body-part index and/or body-part probability distribution. The machine-learning approach analyzes a user with reference to information learned from a previously trained collection of known poses. During a supervised training phase, for example, a variety of human subjects may be observed in a variety of poses; and trainers may provide ground truth annotations labeling various machine-learning classifiers in the observed data. The observed data and annotations are then used to generate one or more machine-learned algorithms that map inputs (e.g., observation data from a depth camera) to desired outputs (e.g., body-part indices for relevant pixels).

In some embodiments, a virtual skeleton is fit to the pixels of depth data that correspond to a user. The virtual skeleton includes a plurality of skeletal segments pivotally coupled at a plurality of joints. In some embodiments, a body-part designation may be assigned to each skeletal segment and/or each joint. A virtual skeleton consistent with this disclosure may include virtually any type and number of skeletal segments and joints.

In some embodiments, each joint may be assigned various parameters—e.g., Cartesian coordinates specifying joint position, angles specifying joint rotation, and additional parameters specifying a conformation of the corresponding body part (hand open, hand closed, etc.). The virtual skeleton may take the form of a data structure including any, some, or all of these parameters for each joint. In this manner, the metrical data defining the virtual skeleton—its size, shape, and position and orientation relative to a coordinate system (e.g., world space) may be assigned to the joints.

Via any suitable minimization approach, the lengths of the skeletal segments and the positions and rotational angles of the joints may be adjusted for agreement with the various contours of the depth map. This process may define the location and posture of the imaged user. Some skeletal-fitting algorithms may use the depth data in combination with other information, such as color-image data and/or kinetic data indicating how one locus of pixels moves with respect to another. As noted above, body-part indices may be assigned in advance of the minimization. The body-part indices may be used to seed, inform, or bias the fitting procedure to increase the rate of convergence. For example, if a given locus of pixels is designated as the head of the user, then the fitting procedure may seek to fit to that locus a skeletal segment pivotally coupled to a single head joint. If the locus is designated as a forearm, then the fitting procedure may seek to fit a skeletal segment coupled to two joints—one at each end of the segment. Furthermore, if it is determined that a given locus is unlikely to correspond to any body part of the user, then that locus may be masked or otherwise eliminated from subsequent skeletal fitting. In some embodiments, a virtual skeleton may be fit to each of a sequence of frames of depth video. By analyzing positional change in the various skeletal joints and/or segments, the corresponding movements—e.g., gestures, actions, behavior patterns—of the imaged user may be determined.

The foregoing description should not be construed to limit the range of approaches that may be used to construct a virtual skeleton, for a virtual skeleton may be derived from a depth map in any suitable manner without departing from the scope of this disclosure. Moreover, despite the advantages of using a virtual skeleton to model a human subject, this aspect is by no means necessary. In lieu of a virtual skeleton, raw point-cloud data may be used directly to provide suitable posture information.

Once modeled, a virtual skeleton or other machine-readable representation of a user may be used to determine a current user viewpoint. As introduced above, the image controller may supply an aimed projector with information for projecting an image that is geometrically corrected for a target location and a user's current viewpoint.

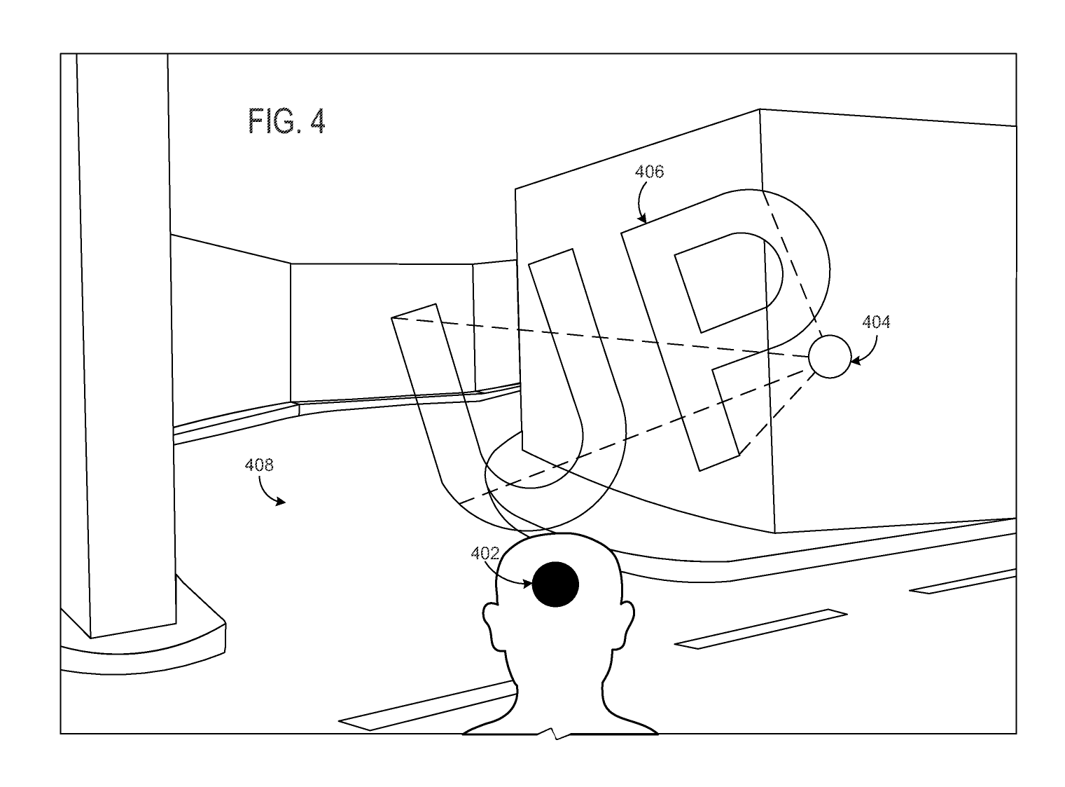

FIG. 4 shows an arbitrary user viewpoint 402, a depth camera viewpoint 404, and a projected image 406 in a physical environment 408. FIG. 4 is drawn such that projected image 406 appears as it would from arbitrary user viewpoint 402. Projected image 406 is geometrically corrected for arbitrary user viewpoint 402. In other words, the imaging light is predistorted to compensate for the irregular surfaces onto which the light is projected and for the off-axis user viewpoint.

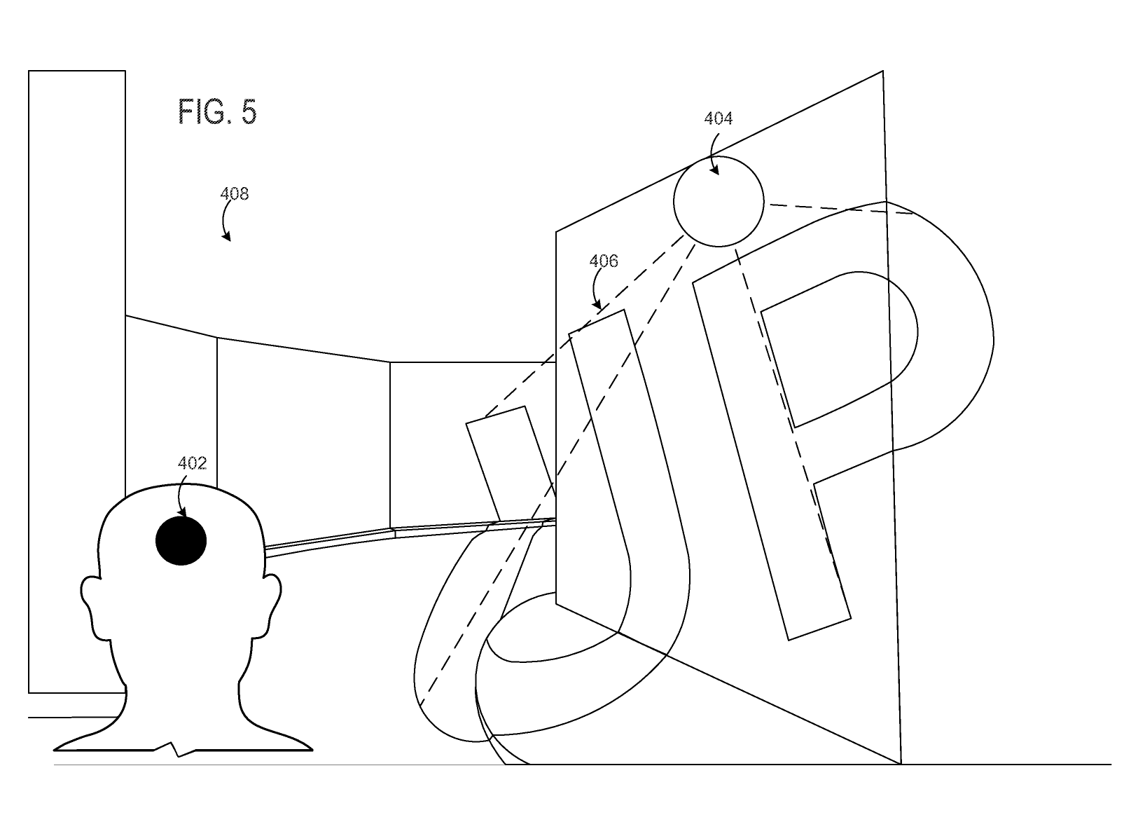

Next, FIG. 5 shows projected image 406 in physical environment 408 viewed from depth camera viewpoint 404. As seen from this perspective, projected image 406 is predistorted so that it will appear undistorted from arbitrary user viewpoint 402. Geometric correction of the projected image 406 may be updated in real time so that the position and shape of the projected image viewed from arbitrary user viewpoint 402 will not change as the steerable display system and/or the user viewpoint moves.

As another example, geometrically corrected images may be projected onto arbitrarily shaped objects in a room so that the geometrically corrected images look “painted” onto objects. For example, a map of the earth may be projected onto a spherical object so that the spherical object resembles a visually correct geographical globe of earth.

The image controller may also correct colors of projected images according to colors of surfaces at the target location. For example, to create the appearance of a purple object, a steerable display system may project red light onto a blue object.

As discussed above, a skeletal tracker or other human modeler may be used to analyze information from the depth camera and to derive a virtual skeleton or other model representing a human subject present in a physical environment. In this way, a user viewpoint may be determined, for example. The skeletal tracker or other modeler also can be used to facilitate virtual interactions between a user and projected virtual objects. For example, a user may pick up or move virtual objects sitting on a table.

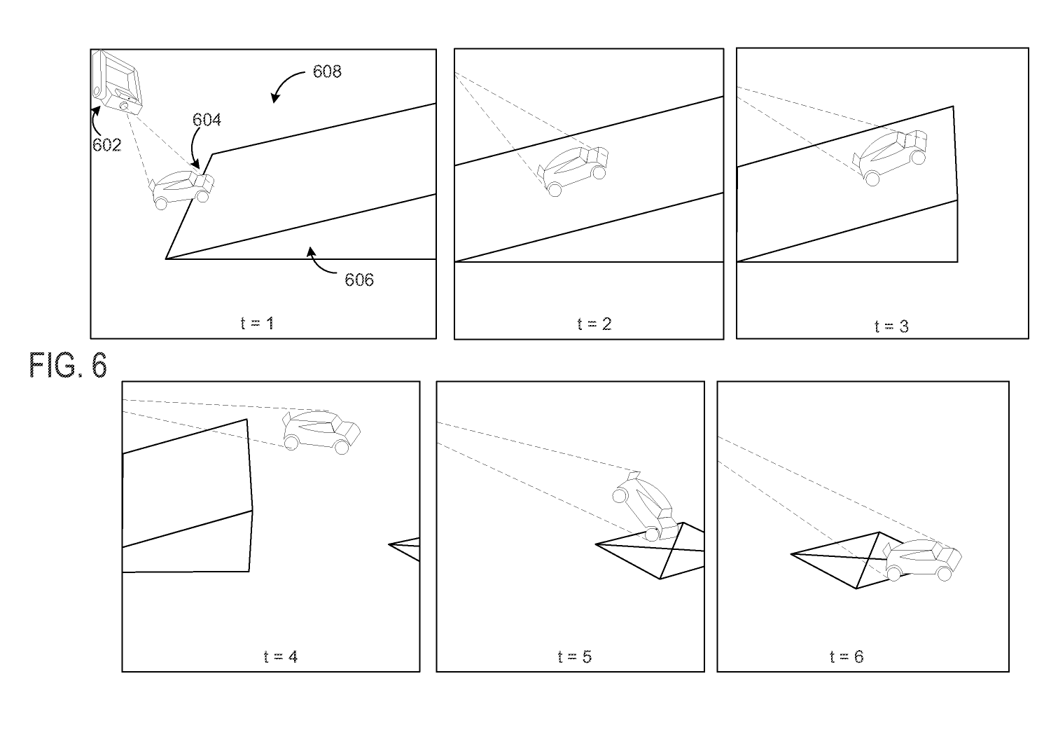

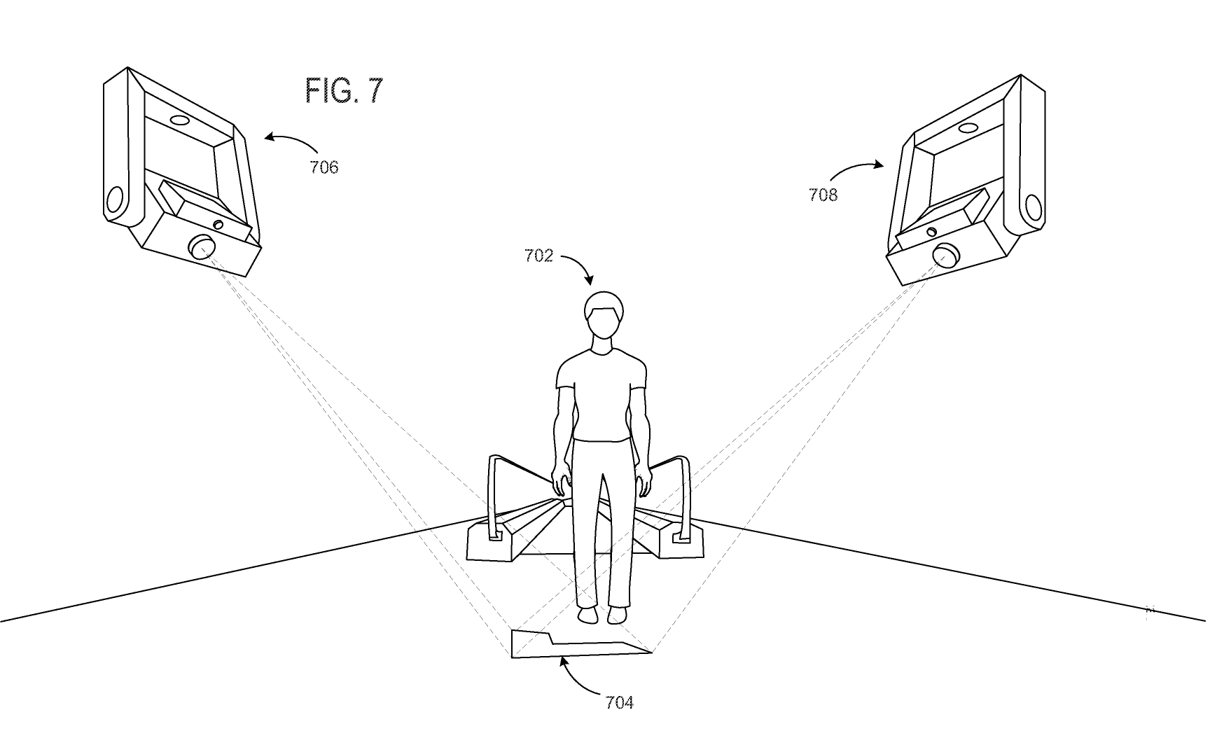

FIG. 6 shows steerable display system 602 projecting a geometrically corrected image 604 of a virtual car that is being remotely controlled by a user. For example, a user may use a peripheral game pad or natural user interface gestures to control the steering and throttle of the car. In FIG. 6, the virtual car is racing up a ramp 606 in a physical environment 608. The image 604 is geometrically corrected in real time for a particular user viewpoint. The car may follow a dynamic physics engine that utilizes depth information from the physical environment to update in real time a model of the physical environment. For example, if a user moves ramp 606 to a different location, the new position of the ramp can be assessed so that the car will appear to drive up the ramp at the ramp's new position as opposed to driving through the ramp along the ground.

The image controller may supply information for projecting a rotated image, differently-aimed images having different fields of view (e.g., for spotlighting), and/or images having two or more different resolutions. Projected images may be geometrically corrected for multiple fields of view. Furthermore, a resolution of a projected image may be varied based on a distance of the projected image from a user viewpoint.

The aiming controller and the image controller of a plural-projector system may be configured to cooperatively cause different projectors to project a moving image that travels along a path that is not within a displayable area of any one of the plurality of different projectors. For example, FIG. 7 shows a user 702 following a moving projected image 704 of an arrow that moves with and is projected in front of the user via projection steering mechanisms 706 and 708. Projection steering mechanisms 706 and 708 may be arranged in an array so that each projection steering mechanism has a different field of view. Projection steering mechanism 706 may follow user 702 until user 702 reaches an edge of a field of view of projection steering mechanism 706. At this point, projection steering mechanism 708 may start projecting the moving image 704. As a result, the projected image 704 appears to continuously and seamlessly move with user 702, even if the user steps out of the field of view of projection steering mechanism 706. Further, as shown in FIG. 7, two or more projectors may simultaneously project the same images with different geometric corrections. Such double projecting may increase brightness and/or help mitigate occlusions.

As another example, the aiming controller and the image controller may be configured to cooperatively cause different projectors to stereo project images that are geometrically corrected for the target location. Furthermore, the stereo projected images may be interleaved and synchronized for shuttered viewing (e.g., via shutter glasses). Such an arrangement allows for projection of two separate images onto the same terrain. This could be used to provide slightly different images for each eye eye to create the illusion of a three-dimensional object, or to provide different images to different viewers. Furthermore, such a shuttered approach could be used to project different perspective renderings of the same object for different viewers, each appearing correct for that user's vantage point.

In some embodiments, the methods and processes described herein may be tied to a computing system of one or more computing devices. In particular, such methods and processes may be implemented as a computer-application program or service, an application-programming interface (API), a library, and/or other computer-program product.

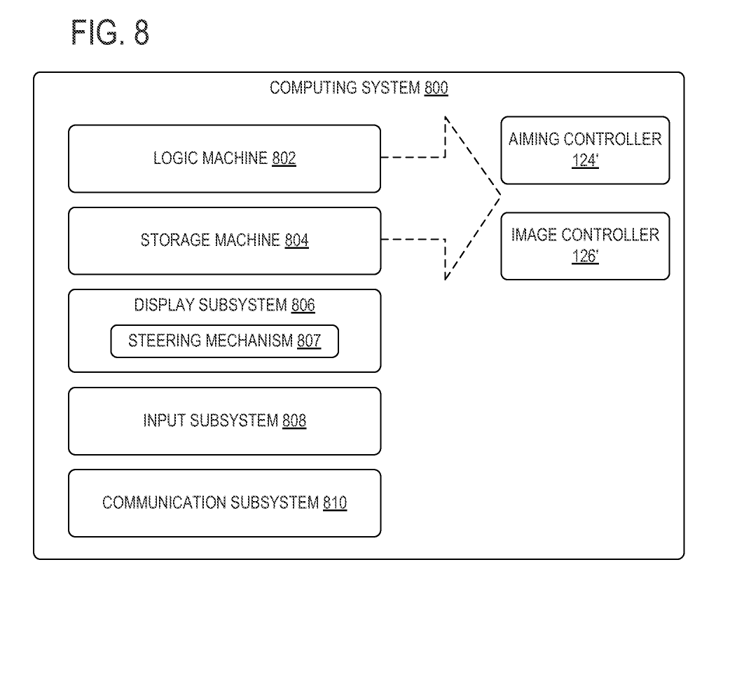

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices.

Computing system 800 includes a logic machine 802 and a storage machine 804. The logic machine and storage machine may cooperate to implement an aiming controller 124′ and/or image controller 126′. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 804 includes one or more physical devices configured to hold instructions executable by the logic machine to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

In some embodiments, the same logic machine and storage machine may be used to drive two or more different projectors, two or more different depth cameras, and/or two or more different projection steering mechanisms.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of projection technology. Such display devices may be combined with logic machine 802 and/or storage machine 804 in a shared enclosure, or such display devices may be peripheral display devices. As discussed with reference to FIG. 1, such display devices may be aimed via a steering mechanism 807.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A steerable display system, comprising:
a depth camera to three-dimensionally model a physical environment;
a projector;
a projector steering mechanism to selectively change a projection direction of the projector;
an aiming controller to cause the projector steering mechanism to aim the projector at a target location of the physical environment; and
an image controller to supply the aimed projector with information for projecting an image that is geometrically corrected for the target location.

2. The steerable display system of claim 1, where the depth camera is mounted to the projector steering mechanism and aims with the projector.

3. The steerable display system of claim 1, where the depth camera aims independently from the projector.

4. The steerable display of claim 1, where the depth camera models the physical environment as a plurality of voxels.

5. The steerable display of claim 1, where the plurality of voxels are derived from depth camera information taken from two or more different fields of view of the depth camera.

6. The steerable display of claim 1, where the projector steering mechanism is configured to rotate the projector about a yaw axis and a pitch axis that is perpendicular to the yaw axis.

7. The steerable display of claim 1, where the projector steering mechanism is configured to rotate the projector about a yaw axis, a pitch axis that is perpendicular to the yaw axis, and a roll axis that is perpendicular to the yaw axis and the pitch axis.

8. The steerable display of claim 1, where the projector steering mechanism is configured to translate a horizontal position of the projector.

9. The steerable display of claim 1, where the image controller is configured to supply the aimed projector with information for projecting a rotated image to the target location.

10. The steerable display of claim 1, further comprising a skeletal tracker to analyze information from the depth camera and to derive a virtual skeleton modeling a human subject present in the physical environment.

11. The steerable display of claim 1, further comprising a viewpoint locator configured to locate a viewpoint of a human subject present in the physical environment.

12. The steerable display of claim 11, where the viewpoint locator uses three dimensional sound source localization to locate the viewpoint of the human subject present in the physical environment.

13. The steerable display of claim 11, where the viewpoint locator uses skeletal tracking to locate the viewpoint of the human subject present in the physical environment.

14. The steerable display of claim 1, where the projector is one of a plurality of different projectors independently aimable by a plurality of different projection steering mechanisms, and where the aiming controller and the image controller are configured to cooperatively cause different projectors of the plurality of projectors to project a moving image that travels along a path that is not within a displayable area of any single one of the plurality of different projectors.

15. The steerable display of claim 1, where the projector is one of a plurality of different projectors independently aimable by a plurality of different projection steering mechanisms, and where the aiming controller and the image controller are configured to cooperatively cause different projectors of the plurality of projectors to stereo project images that are geometrically corrected for the target location.

16. The steerable display of claim 1, where the stereo projected images are interleaved and synchronized for shuttered viewing.

17. A steerable display system, comprising:
a depth camera;
a projector; and
a steering mechanism to selectively change a yaw and a pitch of both the projector and the depth camera.

18. A steerable display system, comprising:
a depth camera to three-dimensionally model a physical environment;
a projector;
a projector steering mechanism to selectively rotate the projector about a yaw axis and a pitch axis that is perpendicular to the yaw axis;
an aiming controller to cause the projector steering mechanism to aim the projector at a target location of the physical environment; and
an image controller to supply the aimed projector with information for projecting an image that is geometrically corrected for the target location.

19. The steerable display of claim 18, further comprising a skeletal tracker to analyze information from the depth camera and to derive a virtual skeleton modeling a human subject present in the physical environment.

20. The steerable display of claim 18, further comprising a viewpoint locator configured to locate a viewpoint of a human subject present in the physical environment.
